(19) United States
(12) Patent Application Publication
(10) Pub. No.: US 2004/0117778 A1
(43) Pub. Date: Jun. 17, 2004

(54) Optimization of software code using N-bit pointer conversion

(76) Inventors: David C. Sehr, Cupertino, CA (US); Rakesh Ghiya, Santa Clara, CA (US); Kevin J. Smith, Los Gatos, CA (US); Richard B.. Wirt, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/320,281

(22) Filed: Dec. 16, 2002

(51) Int. Cl. G06F 9/45; G06F 12/00

(52) U.S. Cl. 717/152; 711/206

(57) ABSTRACT

A system and method for optimizing software code are provided. Based on user input, a desired segmentation model is determined. Resultant code is generated to replace smaller N-bit pointers, when feasible, for larger pointers in the source code, while maintaining the desired segmentation model.

### BACKGROUND

1. Technical Field

The present invention relates generally to information processing systems and, more specifically, to compiling/assembling software code to optimize performance on a processor that supports at least two pointer lengths.

2. Background Art

In the evolution of microprocessor design, both 32-bit architectures and 64-bit architectures have emerged. During this evolution, of course, software was generated for use on 32-bit processors. In some cases, it has become desirous to run such 32-bit software on a 64-bit processor. Many such 32-bit software programs are pointer-intensive. For instance, many integer-processing and transaction-processing applications, designed originally to run on 32-bit processors, pervasively utilize pointers and pointer-based dynamic data structures. Pointer-based data structures may in turn contain large numbers of pointer elements. Often, these pointer elements constitute a large portion of the size of the data structures and therefore typically contribute heavily to cache pollution, and also to high cache and translation-lookaside buffer (TLB) miss rates. Embodiments of the method and apparatus disclosed herein address these and other concerns related to performance of 32-bit software applications on 64-bit processors.

### BRIEF DESCRIPTION OF THE DRAWINGS

The present invention may be understood with reference to the following drawings in which like elements are indicated by like numbers. These drawings are not intended to be limiting but are instead provided to illustrate selected embodiments of a method and apparatus for optimizing software code.

FIG. 1 is a flowchart illustrating at least one embodiment of a method for generating resultant code for a source program such that the resultant code utilizes N-bit pointers where feasible.

FIG. 2 is a flowchart illustrating a more detailed view of the processing for an embodiment of the method illustrated in FIG. 1.

FIGS. 3, 4, 5 and 6 are flowcharts illustrating at least one embodiment of a method for analyzing code to mark appropriate pointers as N-bit pointers.

FIG. 7 is a flowchart illustrating at least one embodiment of a method for determining whether an assignment statement causes a structure type to escape the current compilation scope.

FIG. 8 is a block diagram illustrating at least one embodiment of a computer system capable of compiling a software program to utilize N-bit pointers.

FIG. 9 is a flowchart illustrating an embodiment of code generation processing for the zero base segmentation model.

FIG. 10 is a flowchart illustrating an embodiment of code generation processing for the single base segmentation model.

FIG. 11 is a flowchart illustrating an embodiment of code generation processing for the multi-base segmentation model.

FIG. 12 is a flowchart illustrating an embodiment of code generation processing for the typed multi-base segmentation model.

### DETAILED DISCUSSION

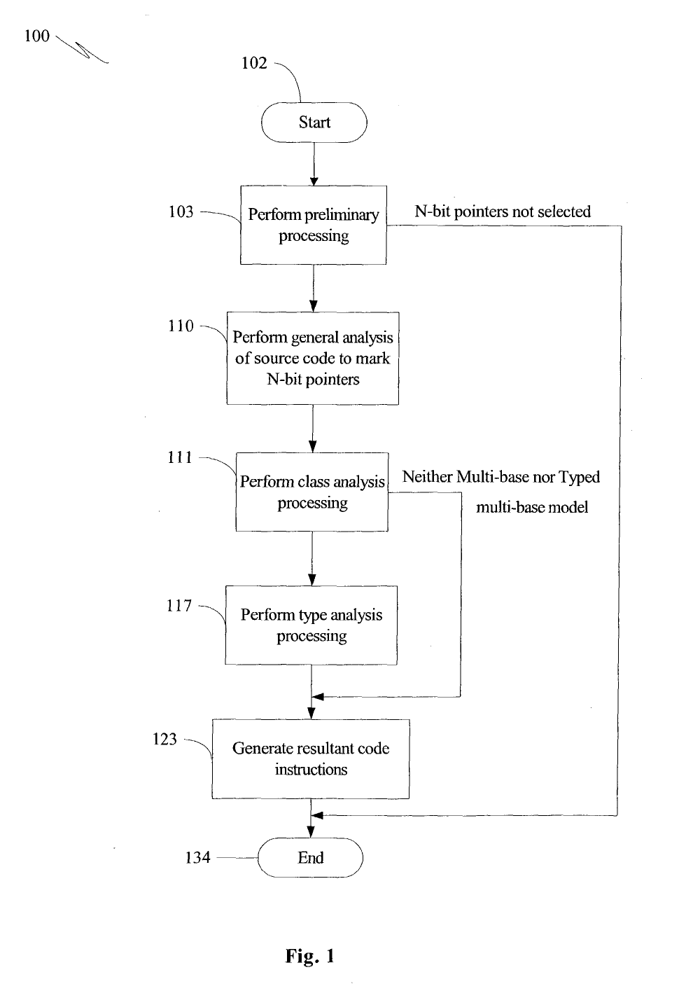

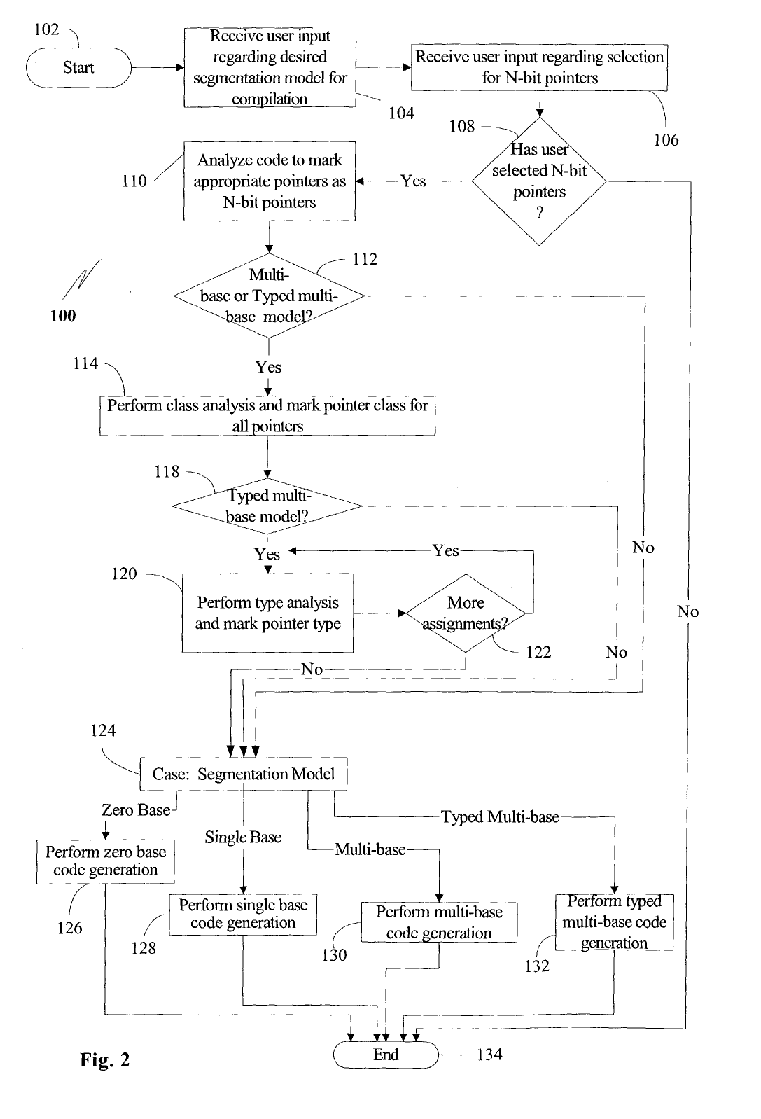

FIGS. 1 and 2 are flowcharts illustrating embodiments of a method 100 for optimizing software source code to utilize N-bit pointers. FIG. 1 is a general view, while FIG. 2 is a more detailed view of an embodiment of the optimization method 100. Such optimization is performed, for at least one embodiment, by a compiler. However, the optimization method 100 is not so limited, and can also be performed in other known manners, such as manually or by an assembler. As used in herein, when reference is made to a “compiler” performing the method 100, it will be understand that any other known manner of performing the method is also intended by such statements.

The method 100 provides for generation of optimized code by utilizing N-bit pointers, where feasible, in the resultant code. As used herein, the term “resultant” code is intended to encompass binary code that is generated by a compiler, hand-generated binary code, assembled code generated by an assembler, hand-assembled code, and the like.

An N-bit pointer is a pointer having a bit length of N, where N is less than architectural bit-length of the processor on which the resultant code is intended be executed, where N is also a power of two. For purposes of example, the discussion below sometimes assumes that N is 32 and that the optimized code is intended to be executed on a 64-bit processor. However, one should note that embodiments of the method 100 illustrated in FIGS. 1 and 2 may be used to enhance performance on any processor (such as 32-bit, 64-bit, 128-bit, etc.) and that N can be any power-of-two number smaller than the architectural limit of the intended processor.

Although a larger (such as 64-bit) pointer affords a large address range, it may nonetheless be desirable to use an N-bit pointer to represent the address of an entity. Consider, for example, that data structures utilizing 64-bit pointers may grow to twice the size of similar data structures that utilize 32-bit pointers. The increase in the size of the 64-bit data structure causes a corresponding increase in cache misses and TLB misses, and can cause performance degradation. For any given application, the value of N depends on the address range limitation that can be assumed. For the discussion of selected embodiments herein, a 64-bit default pointer and an N-bit pointer (N=32) will be used for illustrative purposes.

FIG. 1 illustrates a method for utilizing N-bit pointers, where feasible, in resultant code. The method 100 may be performed by hand, or may be performed automatically by a compiler, assembler, or the like. Processing begins at block 102. At block 103, preliminary processing is performed, such as determining user selections for various options relevant to the generation of resultant code. At least one such option is the memory segmentation model to be used for the resultant code. Another such option is whether N-bit pointers should be generated in the resultant code. A user might elect not to use N-bit pointers, for instance, if the source code was written to capitalize on the additional address ranges capable of representation by larger pointers. The remaining blocks 110, 111, 117, 123 are performed if the user has selected the use of N-bit pointers. Otherwise, processing ends at block 134.

If N-bit pointers are desired, a general analysis of the source code is performed 110. During the general analysis 110, information regarding N-bit pointers is recorded.

For an embodiment of the method 100 that is performed by a compiler, the N-bit pointer information is recorded during general analysis 110 in the compiler's representation of the source code. For at least one embodiment, a compiler's representation of a software program includes a symbol table and a list of instructions. The symbol table may further include a representation for each pointer and structure type in the source code. Regarding pointers, each symbol table entry for a pointer may further include fields for values associated with the following attributes: bit length, class, and type. The allowed values for the bit length attribute may include at least two values: the architectural limit of the intended processor (for example, 64 bits) and at least one N-bit value (for example, 32 bits). It is in this attribute field that the pointer length is marked for pointers during the general analysis processing 110. Other attribute values include the permitted values for the class and type attribute fields. For at least one embodiment, the permitted values for the “class” attribute may include “text,” “data,” “stack,” “heap,” and “any.” The permitted values for the “type” attribute may include “any” as well as any type that appears in the source code. Regarding structure types, each symbol table entry for a structure type may include a field to indicate whether the structure type has escaped the current compilation scope. In addition to the general analysis performed at block 110, additional analysis may be performed for certain memory segmentation models. At block 111 it is determined whether class analysis should be performed and, if so, such analysis is performed. If not, processing proceeds to block 123.

Similarly, at block 117 it is determined whether type analysis should be performed and, if so, such analysis is performed. If not, processing falls through to block 123.

After block 117 has been performed, it is assumed that all pointers for which it is feasible to utilize N-bit representation have been so marked in the symbol table. Processing proceeds to block 123, where resultant code is generated. During such generation, resultant code instructions are generated to utilize N-bit pointers as indicated by the symbol table attributes.

FIGS. 1 and 2 are referenced together in connection with a more detailed discussion of the processing associated with blocks 103, 110, 111, 117, 123 of FIG. 1. Regarding block 103, FIG. 2 illustrates the detailed processing 104, 106, 108 associated with the preliminary processing of block 103 (FIG. 1). At block 104, it is determined which segmentation model the user desires for the resultant code to be produced during compilation or assembly. The chosen segmentation model may drive the selection of how pointers will be grouped in the logical address space allocated for the resultant code during execution. It is then determined 108, based on user input received at block 106, whether the user wishes for the resultant code to be optimized with N-bit pointers. If not, processing ends at block 134.

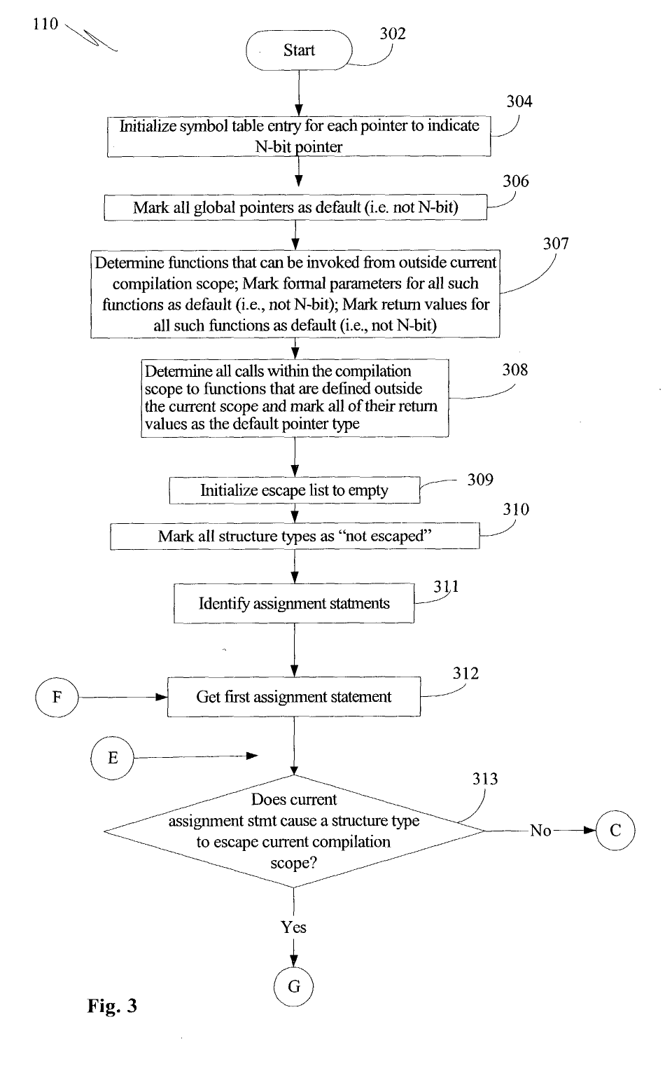

If it is determined 108 that the user wishes for the resultant code to utilize N-bit pointers (where feasible), then processing continues a block 110. At block 110, the instructions of the source code are analyzed to generally determine which software entities, such as variables, objects and the like, may be indicated by N-bit pointers in the resultant code. More detailed processing associated with at least one embodiment of block 110 is discussed in further detail below in connection with FIGS. 3 through 6.

FIGS. 1 and 2 illustrate that, after general analysis is performed at block 110, more specific analysis blocks 111, 117 are performed. The class analysis processing 111 illustrated in FIG. 1 further includes, for at least one embodiment, blocks 112 and 114 as illustrated in FIG. 2. The type analysis processing 117 illustrated in FIG. 1 further includes, for at least one embodiment, blocks 118, 120 and 122 as illustrated in FIG. 2.

Regarding class analysis processing 111, FIG. 2 illustrates that, if it is determined 112 that the user has selected 104 the multi-base or typed multi-base segmentation model, then processing continues at block 114. If not, processing proceeds, generally, to the code generation block 123 (FIG. 1). More specifically, processing proceeds to block 124 illustrated in FIG. 2.

At block 114, class analysis is performed on the set of assignments in the source code. If the user has selected 104 a multi-base segmentation model, the user has effectively requested that each allowed pointer class be associated with a different base pointer in the executable code. For at least one embodiment, the allowed pointer classes include stack, heap, static and data. In order to enforce the user's chosen segmentation model, the method 100 provides that a pointer to an entity of a particular class will only point to an address within a specified segment of logical memory addresses. The segment is a range of logical addresses assigned to a pointer class. At block 114, the following processing may occur. For each pointer in the source code that can only point to objects in the instruction stream, the symbol table entry for such pointer is modified to indicate that the pointer is of storage class “text.” For each pointer that can only point to objects in the stack, the symbol table entry for such pointer is modified to indicate that the pointer is of storage class “stack.” Similarly, the symbol table entry for each pointer that can only point to objects in the static data area is modified to reflect storage class “data,” while the symbol table entry for each pointer that can only point to objects in the heap segment is modified to reflect storage class type “heap.” If the storage class cannot be determined for a pointer, the storage class for that pointer is recorded as “unknown” in the symbol table. Accordingly, for at least one embodiment, each of the pointers is identified as belonging to one of the permitted storage classes, if possible, and is therefore designated as belonging in a particular segment. As stated above, each storage class is associated with a particular segment of memory, and each memory segment is associated with a different base pointer. One skilled in the art will recognize that such processing 114 need not be performed if zero base or single base segmentation models have been selected 104.

Regarding type analysis processing 117 (FIG. 1), FIG. 2 illustrates that additional model-specific analysis 120, 122 is performed if the user has selected 104 the typed multi-base segmentation model. For the typed multi-base segmentation model, each of the storage classes may be associated with a plurality of pointer types. For example, there may be multiple pointer types stored in the heap segment and/or multiple pointer types stored in the stack segment and/or multiple pointer types stored in the data segment. The plurality of pointer types stored in one segment may or may not match the plurality of pointer types stored in another segment. At block 118, it is determined whether the user has selected 104 the typed multi-base segmentation model. If not, processing proceeds, generally, to the code generation block 123 (FIG. 1). More specifically, processing proceeds to block 124 illustrated in FIG. 2. If it is determined 118 that the user has chosen the typed multi-base segmentation model, processing proceeds to block 120.

At block 120, type analysis is performed for each assignment in the source code. For each pointer that can only point to objects of a given source type, x, the pointer's symbol table entry is modified to reflect type=“x”. If the type for a pointer cannot be accurately determined, its symbol table entry is modified to reflect type=“unknown.” A check is performed 122, effectively creating a loop 120, 122 to process the type for each assignment in the source code.

Code generation processing 123 of FIG. 1 includes, for at least one embodiment, blocks 124, 126, 128, 130 and 132 as illustrated in FIG. 2. Based on the segmentation model selected by the user at block 104, a case selection is performed at block 124. That is, if the zero base segmentation model has been selected 104, then block 126 is performed. If, on the other hand, the single base segmentation model has been selected 104, then block 128 is performed. Similarly, block 130 is performed if the multi-base segmentation model has been selected 104, and block 132 is performed if the typed multi-base segmentation model has been selected 104.

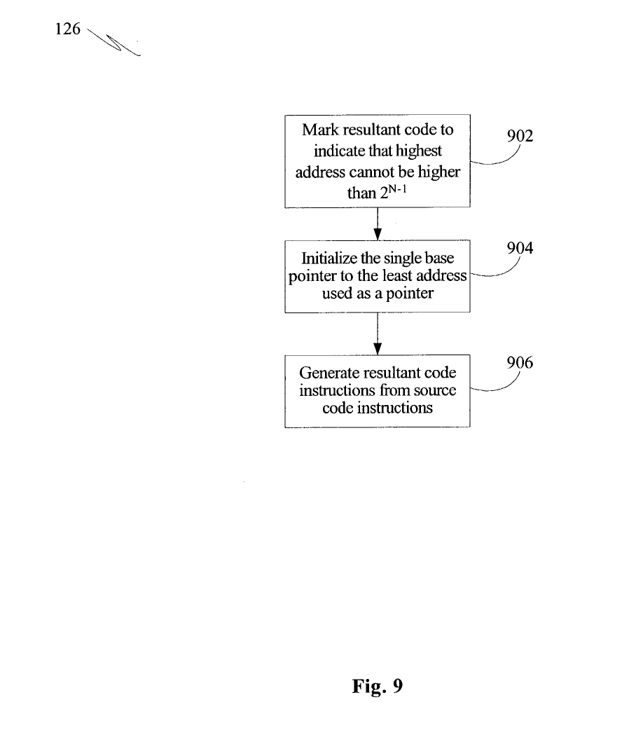

FIGS. 2 and 9 illustrate that, at block 126, code generation processing for the zero base segmentation model is performed. By way of background information, it should be noted that, for the zero base segmentation model, all pointers are placed in a single segment. Accordingly, during the processing at block 126, the resultant code is marked 902 to be laid out in memory such that the highest address in the resultant program code is no larger than 2^{N-1}. That is, the highest address in the resultant code does not exceed the highest address that can be represented with N bits. For an embodiment wherein the method 100 is performed by a compiler, linker (not shown) and loader (not shown) support may be used to enforce such address restriction.

For all of the base pointer segmentation models, the start up code for the resultant program initializes the base pointer(s) as appropriate to the model. During the code generation processing 126, 128, 130, 132, therefore, instructions are generated so that the start up code will initialize such pointers appropriately. For instance, at block 126, code is generated 904 to initialize the single base pointer to the least address used as a pointer. Although the segmentation model is called the “zero base” model, the base address is usually not zero.

In addition to generating instructions 902 for the resultant code to indicate a minimum load address and generating instructions 904 to initialize the base pointer for the single segment, resultant code instructions are generated 906 for the instructions in the source program. For an embodiment wherein the method 100 is performed by a compiler, the instructions are generated 906 for the instructions in the list of source code instructions maintained by the compiler. As the resultant code instructions are generated 906, all pointers whose symbol table entries are marked as “N-bit” are treated as having reduced size and are placed within the zero-base segment.

Returning to FIG. 2, blocks 128, 130 and 132 represent code generation processing for single base, multi-base, and typed multi-base segmentation models, respectively. Each of them 128, 130, 132 relates generally to initializing base pointers and generating resultant code instructions for instructions in the source code, including special processing for address-taking and dereferencing operations.

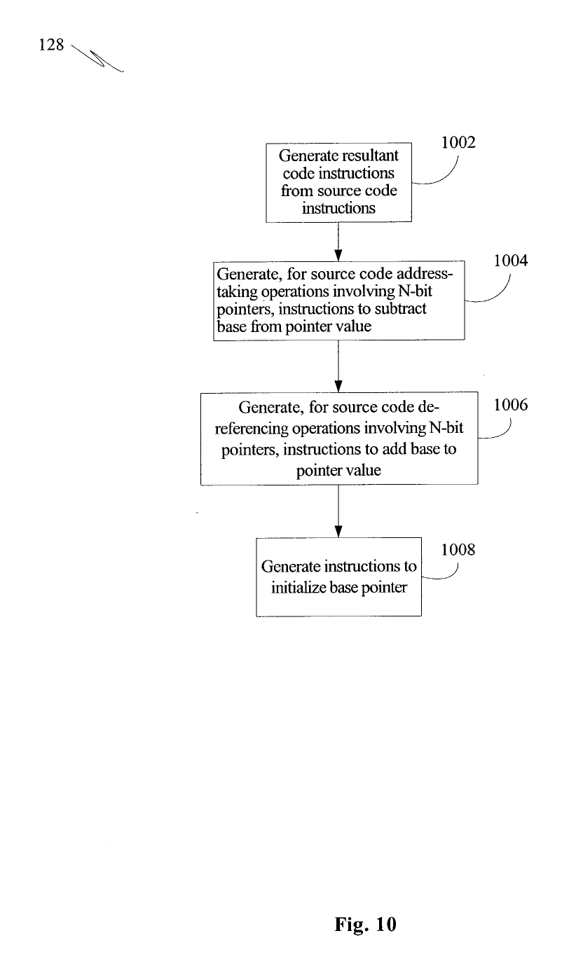

Specifically, FIGS. 2 and 10 illustrate that block 128 represents code generation processing for the single base segmentation model. As with all the other models, resultant code instructions are generated 1002 for the instructions in the source program. As such instructions are generated 1002, those pointers whose symbol table entries are marked as “N-bit” are treated as having reduced size and are placed within the single base segment. In addition, address-taking and de-referencing instructions are added to the instructions of the resultant code. For address-taking, code is generated 1004 for all address-taking operations involving N-bit pointers such that a variable, referred to herein as “base”, is subtracted from the pointer value to generate a modified pointer value. The modified pointer value is used for the address-taking operation in the resultant code. Similarly, code is generated 1006 for all de-referencing operations involving N-bit pointers. That is, code is generated to add the “base” value to the value of an N-bit pointer to generate a modified pointer value. The modified pointer value is used for the de-referencing operation in the resultant code. In addition, instructions to initialize the base pointer for the single base segmentation model are generated 1008. Accordingly, code is generated at block 1008 to initialize the variable base pointer on every path from the entry of the program to point to the lowest address in the program's memory.

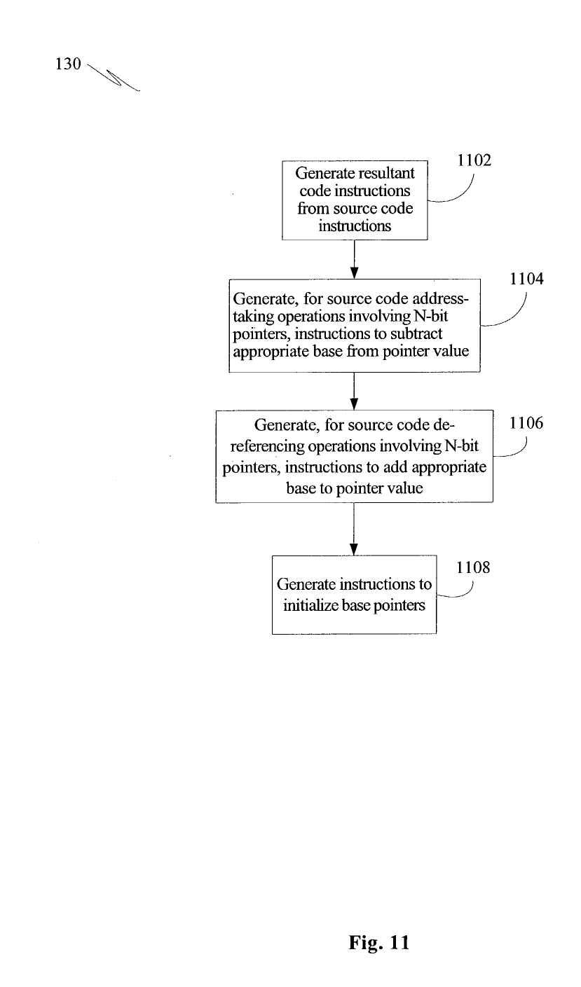

FIGS. 2 and 11 are referenced for further discussion of the code generation processing 130 for the multi-base model. At block 1102, resultant code instructions are generated for the instructions in the source program. As such instructions are generated 1102, those pointers whose symbol table entries are marked as “N-bit” are treated as having reduced size. Such pointers are placed within the segment associated with the pointer's storage class indicator in the attribute list maintained for the pointer in the symbol table. In addition, instructions are generated 1104 in the resultant code for each address-taking operation in the source code that utilizes N-bit pointers. Specifically, code is generated 1104 for all address-taking operations involving N-bit pointers to subtract the appropriate base pointer variable from the pointer value to generate a modified pointer value. For N-bit pointers whose symbol table entries indicate storage class of type “text”, resultant code is generated 1104 to subtract a base value associated with the text segment from the pointer value to generate the modified pointer value. Similarly, for N-bit pointers whose symbol table entries indicate storage class of type “data”, resultant code is generated 1104 to subtract a base value associated with the data segment from the pointer value to generate a modified pointer value. Likewise, instructions to subtract a base value associated with the stack segment from the pointer value for N-bit pointers whose symbol table entries indicate storage class of type “stack” are generated 1104. Also, instructions to subtract a base value associated with the heap segment is subtracted from the value of N-bit pointers whose symbol table entries indicate storage class of type “heap” are generated 1104. Of course, if the symbol table reflects that no entities of a particular type are present, then no address-taking instructions for that type's base pointer are generated 1104. These modified pointer values created by the generated 1104 instructions are used in the resultant code to perform address-taking for the respective N-bit pointers.

At block 1106, code is also generated in the resultant code for each de-referencing operation in the source code that utilizes N-bit pointers. For each such de-referencing operation, instructions are generated 1106 to add an appropriate base value to the pointer value to generate a modified pointer value. The modified pointer value is used for the de-referencing operation in the resultant code. The base pointer added to the N-bit pointer value is the base value corresponding to the N-bit pointer's storage class, as is described in the immediately preceding paragraph.

Code is generated 1108 to initialize base variables on every path from the entry of the program. Code is generated 1108 to initialize the base address for the text storage segment to the lowest address used to store instructions. Code is generated 1108 to initialize the base address for the data segment to the lowest address used to store static data. Code is generated to initialize the base address of the stack segment to the starting address of the stack. And, code is generated 1108 to initialize the base address for the heap segment to the lowest address returned by heap allocation functions.

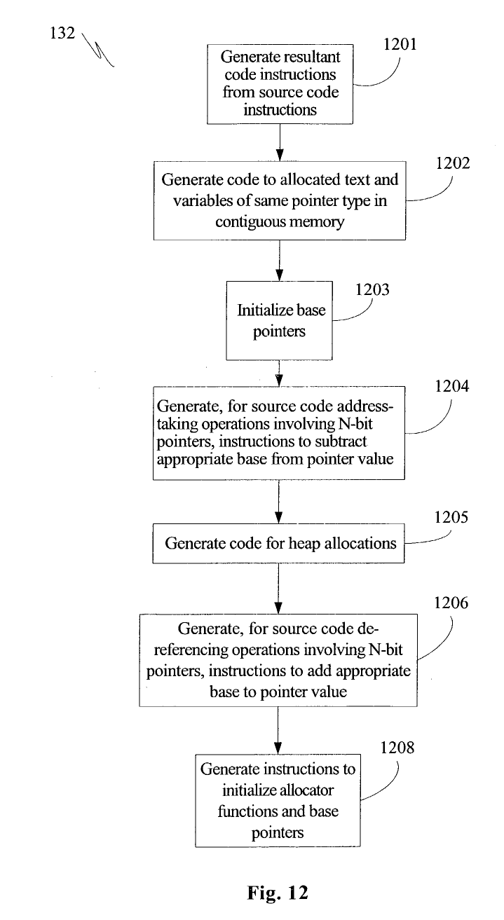

FIGS. 2 and 12 illustrate that, at block 132, code generation processing for the typed multi-base segmentation model is performed. The discussion set forth herein illustrates that the typed multi-base code generation processing 132 is similar to the multi-base code generation processing 130 discussed above, except that the code generation processing 132 for the typed multi-base segmentation model is more detailed in that it takes multiple pointer types into account for each storage class. Accordingly, while generating 1201 resultant code from the instructions in the source code, the block 132 processing treats as having a reduced size all pointers whose symbol table entries indicate that they are N-bit pointers except that pointers marked as having storage type “stack” or “any” are not treated as having reduced size.

Instructions are generated 1202 for the resultant code such that all text and variables of the same pointer type are allocated contiguously in memory. Based on this processing, a base pointer for each storage class/pointer type attribute pair is initialized 1203 to point to a location within such contiguous memory range. Table 1, below, provides an example of such contiguous allocation and related base pointers.

TABLE 1

| Pointer variable | Storage | Pointer type (contiguous memory |
|---|---|---|
| (points to) | class | locations for like types) |
| Text_base_s → | text | Type s |
| | text | Type s |
| Data_base_s → | data | Type s |
| | data | Type s |
| | data | Type s |
| Text_base_t → | text | Type t |
| | text | Type t |
| Data_base_t → | data | Type t |
| | data | Type t |
| ... | ... | ... |

In addition, for each source code address-taking operation involving an N-bit pointer, instructions are generated 1204 for the resultant code. For each such address-taking operation, code is generated 1204 in the resultant code to subtract the appropriate value to generate a modified pointer value that will be used in the resultant code. For example, using the Table 1 example for illustration, for N-bit pointers whose symbol table entries indicate that they are of storage class “text” and type s, instructions would be generated 1204 such that the value of text_base_s is subtracted from the pointer value to generate the modified pointer value to be used for address-taking in the resultant code. Similarly, for illustrative N-bit pointers whose symbol table entries indicate that they are of storage class “data” and type s, instructions would be generated 1204 such that the value of data_base_s is subtracted from the pointer value to generate the modified pointer value for the resultant code. Similarly, instructions to subtract a different value, data_base_t from the pointer value would be generated 1204 for N-bit pointers of data storage class and type t. Also, code is generated for all address-taking operations involving N-bit pointers of storage class “heap” such that the appropriate base address value for each type is subtracted from the pointer value to generate a modified pointer value to be used in the resultant code. For example, for N-bit pointers whose symbol table entries indicate storage class of “heap” and type s, an instruction subtracting a variable such as heap_base_s might be subtracted from the pointer value for address-taking operations in the resultant code. In sum, a base address value is initialized 1203 to the first address of teach type within a storage class; instructions to subtract that base address value from the pointer value are generated 1204 in the resultant code for address-taking operations.

The code generation processing 132 further generates 1205 instructions for the resultant code to facilitate the desired segmentation as it relates to the heap. For all source code heap allocation functions whose values are assigned to N-bit pointers, the allocations are segmented. That is, for each heap allocation that is assigned to an N-bit pointer of type x, instructions are generated 1205 such that the resultant code uses an allocator function specifically for objects of type x. Accordingly, the resultant code uses a specific heap allocator for each type of N-bit pointer in the heap storage class.

At block 132, resultant code instructions are also generated 1206 for source-code dereferencing operations for N-bit pointers. Resultant code for all source code dereferencing operations involving N-bit pointers is generated to add the appropriate base address variable to the N-bit pointer value before performing the memory reference. As is described above, preceding paragraph, each type within a storage class is associated with a different base address variable.

Block 132 also involves generating 1208 resultant code instructions to initialize the specific allocator functions along every path from the entry of the program. The initialization seeks to provide that each type has sufficient space to completely utilize the reduced address of the pointer. Resultant code instructions are also generated 1208 to initialize the base address variables for each type within each class at every path from the entry of the program. For example, text_base_s is initialized to the lowest address used to store instructions for functions of type s. Similarly, data_base_s is initialized to the lowest address used to store static data objects of type s, and heap_base_s is initialized to the lowest address returned by the specific heap allocation for pointer type s.

Turning to FIGS. 3, 4, 5 and 6, one can see at least one embodiment of the general analysis 110 discussed briefly above in connection with FIG. 1. During such general analysis processing 110, it is generally determined which software entities, such as variables, objects and the like, may be indicated by N-bit pointers in the resultant code for any of the four segmentation models discussed herein. (As is discussed above in connection with FIG. 2, additional analysis processing 112, 114, 118, 120, 122 may also be performed in connection with certain of the segmentation models.)

FIG. 3 illustrates that processing for the general analysis processing 110 begins at block 302. Processing proceeds to block 304, where the symbol table for each pointer in the source program is optimistically modified to reflect that the pointer is an N-bit pointer. The remainder of the general analysis processing 110 determines those instances in which such optimism is unwarranted and the pointer should be re-marked as a “default” larger pointer (such as a 64-bit pointer) instead. In this manner, the optimistic N-bit initialization is overridden where warranted. During such initialization 304, other attributes maintained in the symbol table for each pointer table may also be initialized. For instance, the storage class and pointer type for each pointer may be initialized to default values.

Generally, pointers that escape the compilation scope for the source application are not candidates to be marked as N-bit pointers. Different situations can cause a pointer to escape the current compilation scope. At block 306, for instance, all global pointers are marked as default pointers in the symbol table, rather than remaining marked as N-bit pointers. Similarly, at block 307, all formal parameters and return values for all functions that can be invoked from outside the current compilation scope are marked in the symbol table as default pointers. Likewise, at block 308, the return values of calls to functions defined outside the current compilation scope are also marked in the symbol table as default pointers.

In addition, structure types can also escape the current compilation scope An escaped structure type renders all its field pointers ineligible to be N-bit pointers. An escape list is maintained to identify the structure types that escape the compilation scope according to a set of rules. FIG. 3 illustrates that the escape list is initialized 309 to “empty” and the symbol table entries for all structure types are initialized 310 to “not escaped.” At block 311, assignments in the source program are identified. For at least one embodiment, a statement is identified 311 as an assignment statement if it falls within the following set of statement types, because an assignment in a program written in a high level programming language such as C or C++ can be normalized into a sequence of assignments from the following set. For simplicity of notation, a reference of the form *p where p is a pointer to type T is represented as (*p).fieldT with fieldT assigned an offset of zero. With this representation, a type with a pointer to it becomes a structure type, including multi-level pointer types. The set of statement types identified as assignments includes:

1. p=q;

2. p=(typecast) q;

3. p=&q;

4. p=&((*q).field);

5. (*p).field=q;

6. (*p).field q;

7. p=q op y.

In addition, a functional call p=foo(a_{—}1, a_{—}2, . . . , a_n) generates the following set of assignments between its actual arguments (a_{—}1, a_{—}2, . . . , a_n) and corresponding formal parameters (f_{—}1, f_{—}2, . . . , f_n). An additional assignment is also generated for the return value, as illustrated in the following set of assignments:

1. f_{—}1=a_{—}1;

2. f_{—}2=a_{—}2;

n. f_n=a_n;

p=return_foo.

In addition, a return statement of the form {return p;} from within a function foo generates the following assignment:

return_foo=p.

The assignment statements identified at block 311 are analyzed to determine whether they render one or more pointers ineligible to be an N-bit pointer. The processing is iterative; each assignment statement is processed.

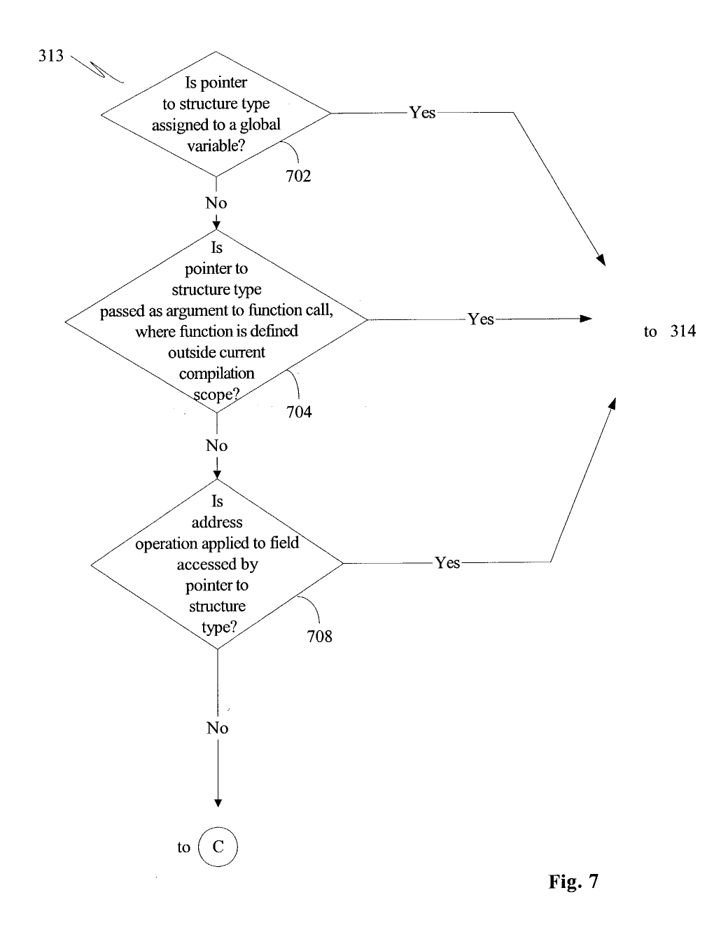

For a first pass through the processing 110, the first assignment is identified 312 as the current assignment. At block 313 it is determined whether the current assignment statement causes a structure type to escape the current compilation scope. Several conditions can cause a structure type to escape the current compilation scope; these conditions are checked at block 313, which is illustrated in further detail in FIG. 7.

Brief reference to FIG. 7 further illustrates the condition checking performed at block 313 of FIG. 3. A structure type is considered to have escaped the current compilation scope if any of the following conditions apply to a pointer, referred to herein as “ptr” for illustrative purposes, to the given structure type: 1) ptr is assigned to a global variable (i.e., global=ptr); 2) ptr is passed as an argument to a function call, with the function defined outside the current compilation scope (i.e., foo(ptr)); or 3) an address operation is applied on a field access through ptr (i.e., (&(ptr→field)).

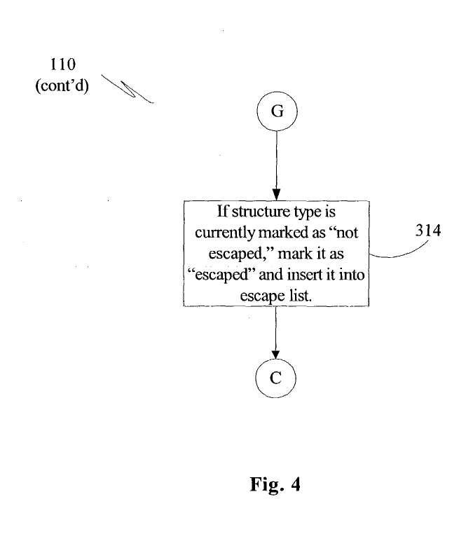

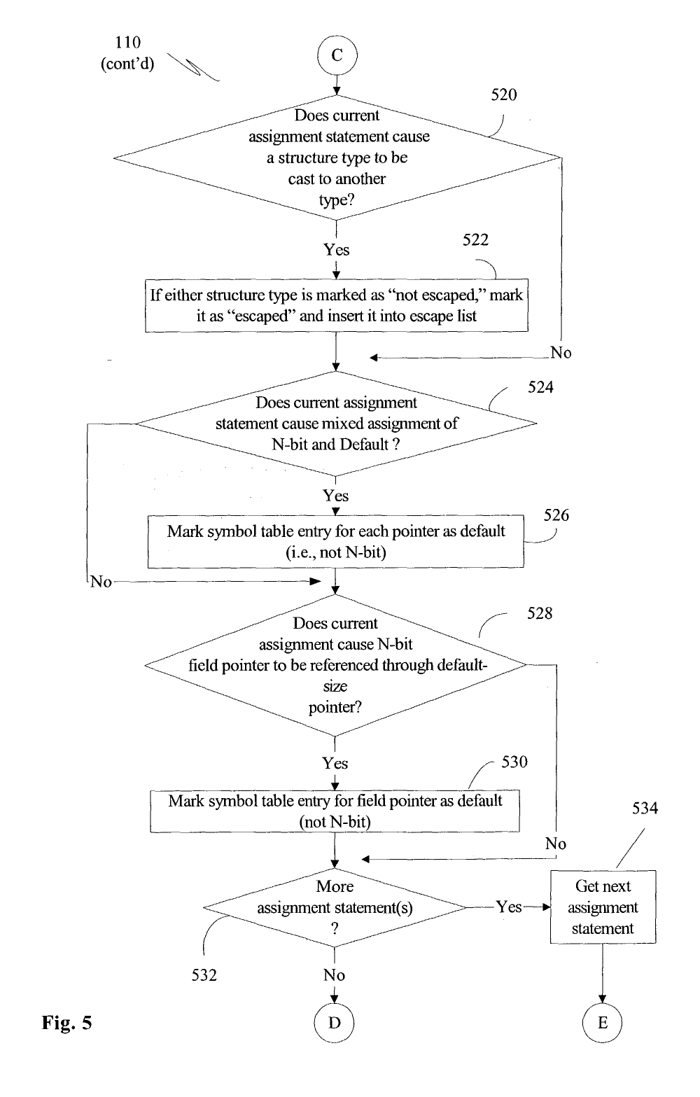

FIG. 7 illustrates that condition 1 is checked at operation 702. If a pointer to the structure type is assigned to a global variable, then processing proceeds to block 314 (FIG. 4). Otherwise, it is determined 704 whether a pointer to the structure type is passed as an argument to a function call, where the function is defined outside the current compilation scope. If so, processing proceeds to block 314 (FIG. 4). Otherwise, it is determined 708 whether an address operation is applied to a field accessed by a pointer to the structure type. If so, the structure type escapes the current compilation scope and processing proceeds to block 314 (FIG. 4). If none of the condition checks 702, 704, 708 evaluates to true, then no structure types have escaped the current compilation scope, and processing proceeds to block 520 (FIG. 5).

FIG. 4 illustrates that, if it is determined at block 313 that the current assignment statement causes a structure type to escape the current compilation scope, then if the structure type is currently marked as “not escaped,” the symbol table entry for the structure type is marked as “escaped” and the structure type is entered into the escape list. Processing then proceeds to block 520 (FIG. 5).

Turning to FIG. 5, the processing 520 through 534 of FIG. 5 illustrates additional general analysis processing 110 that is performed on an assignment from the source code. If it is determined 520 that a first structure type is used in an assignment that has a second structure type on the opposite side of the assignment statement, then it is determined that such assignment is a casting operation of the first structure type. If a casting operation is identified 520, then, if either structure type is currently marked as “not escaped,” it is marked as “escaped” in the symbol table and it is inserted into the escape list at block 522. If however, a casting operation is not identified at block 520, then processing proceeds to block 524.

At block 524, it is determined whether the current assignment causes a mixed assignment of N-bit and default pointers. If so, processing proceeds to block 526 where the symbol table entry for the N-bit pointer, in the assignment is marked as being of default pointer size. Otherwise, processing proceeds to block 528.

At block 528, the list of instructions in the source code are analyzed to determine whether the current assignment causes a field pointer, whose symbol table entry is marked to indicate an N-bit field pointer, to be referenced through a default-size pointer. If so, the N-bit pointer's entry in the symbol table is modified 530 to reflect the default pointer size. If not, processing proceeds to block 532.

At block 532, it is determined whether additional assignments, of those identified at block 311 (FIG. 3), remain to be processed. If so, the next assignment statement is retrieved 534 to become the current assignment, and processing returns to 313, which is illustrated in FIG. 3. In this manner, general analysis 110 is iteratively performed until no further assignments remain to be processed.

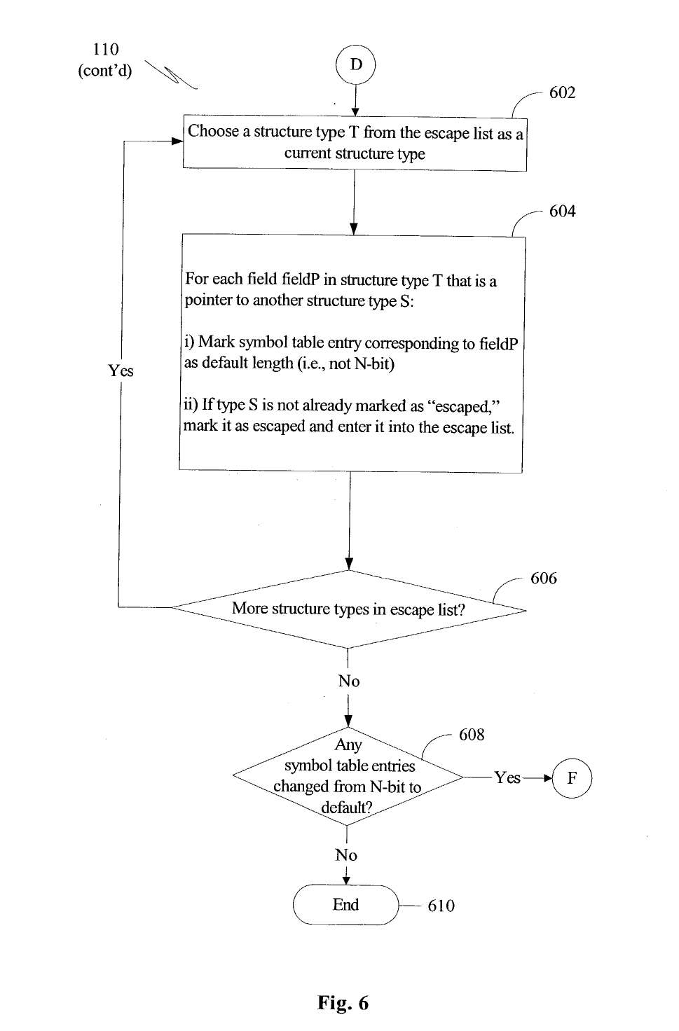

FIG. 6 illustrates that, if no further assignments remain to be processed, then processing continues at block 602. At block 602, iterative processing of the escape list is begun. A structure type T is chosen 602 from the structure types in the escape list. (If the escape list is empty, processing proceeds (not shown) to block 608). The structure type T is processed 604 to mark appropriate symbol table entries as default (i.e., not N-bit) and make further entries in the escape list, if necessary. At block 604, if a structure of type A escapes the current compilation scope, and if structure type A contains a field pointer of structure type B, then structure type B is also considered to have escaped the current compilation scope. While it is determined 606 that there are additional structure types in the escape list, processing returns to block 602, and all entries of the escape list are thus iteratively processed.

At block 608, it is determined whether any pointer's entry in the symbol table has been changed, during the general analysis processing, to reflect the default size rather than N-bit size. If so, then processing returns to block 312 (FIG. 3) to iteratively determine whether any pointer should be changed back from the optimistic N-bit designation to the default size designation.

If it is determined at block 608 that no pointer's symbol table entry has been changed during the current pass to reflect an attribute value of default pointer size rather than N-bit size, processing of the general analysis 110 terminates 610.

In the preceding description, various aspects of creating resultant code from source code such that N-bit pointers are used, where feasible, have been described. For purposes of explanation, specific numbers, examples, systems and configurations were set forth in order to provide a more thorough understanding. However, it is apparent to one skilled in the art that the described methods may be practiced without the specific details. In other instances, well-known features were omitted or simplified in order not to obscure the method.

Embodiments of the method 100 may be implemented in hardware, software, firmware, or a combination of such implementation approaches. Software embodiments of the method 100 may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the dynamic method described herein is not limited in scope to any particular programming language. In any case, the language may be a compiled or interpreted language

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system. The instructions, accessible to a processor in a processing system, provide for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

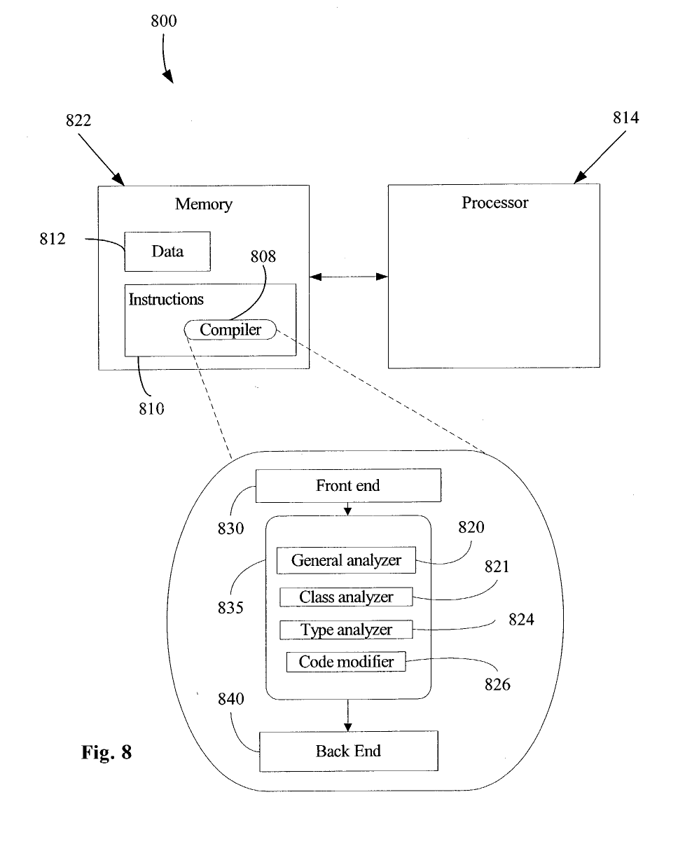

An example of one such type of processing system is shown in FIG. 8. Sample system 800 may be used, for example, to execute the processing for a method of optimizing software code to utilize N-bit pointers, such as the embodiments described herein. Sample system 800 is representative of processing systems based on the Pentium®, Pentium® Pro, Pentium® II, Pentium® III, Pentium® 4, and Itanium® and Itanium® II microprocessors available from Intel Corporation, although other systems (including personal computers (PCs) having other microprocessors, personal digital assistants and other hand-held devices, engineering workstations, set-top boxes and the like) may also be used. In one embodiment, sample system 800 may be executing a version of the Windows™ operating system available from Microsoft Corporation, although other operating systems and graphical user interfaces, for example, may also be used.

Referring to FIG. 8, sample processing system 800 includes a memory system 822 and a processor 814. Memory system 822 is intended as a generalized representation of memory and may include a variety of forms of memory, such as a hard drive, CD-ROM, random access memory (RAM), dynamic random access memory (DRAM), static random access memory (SRAM) and related circuitry.

Memory system 822 may store instructions 810 and/or data 812 represented by data signals that may be executed by processor 814. The instructions 810 and/or data 812 may include code for performing any or all of the techniques discussed herein. For an embodiment wherein the method 100 is performed by a compiler, instructions 810 may include a compiler program 808.

FIG. 8 illustrates that the instructions implementing an embodiment 100 of the method discussed herein may be logically grouped into various functional modules. For an embodiment performed by a compiler 808, the compiler 808 may include a general analyzer 820, a type analyzer 822, a class analyzer 824, and a code modifier 826. For a compiler 808 that includes functional groupings of instructions known as front end 830, optimization 835, and back end 840, the method 100 may be performed with the optimization grouping of instructions 835.

When executed by processor 814, general analyzer 820 performs general analysis 110 pertinent to all four segmentation models as described above in connection with FIGS. 3, 4, 5 and 6. The class analyzer module 821, when executed by the processor 814, performs class analysis processing 111, as described above in connection with FIGS. 1 and 2.

The type analyzer module 826, when executed by the processor 814, performs type analysis processing 117, as is discussed in further detail above in connection with FIGS. 1 and 2.

When executed by the processor 814, the code modifier module 826 generates resultant code instructions in accordance with the chosen segmentation model. Such processing 123 is discussed in further detail above in connection with FIGS. 1, 2, 9, 10, 11 and 12.

While particular embodiments of the present invention have been shown and described, it will be obvious to those skilled in the art that changes and modifications can be made without departing from the present invention in its broader aspects. The appended claims are to encompass within their scope all such changes and modifications that fall within the true scope of the present invention.

What is claimed is:

1. A method comprising:
identifying a selected segmentation model;
marking one or more pointers associated with a source program as N-bit pointers, where N is an integer value less than the architectural limit of a computing device; and
generating resultant code instructions to maintain the selected segmentation model for the one or more N-bit pointers.

2. The method of claim 1, further comprising:
marking one or more pointers associated with the source program as default-length pointers.

3. The method of claim 2, wherein the default-length pointers are of a length corresponding to the architectural limit of the computing device.

4. The method of claim 2, wherein marking one or more pointers associated with the source program as default-length pointers further comprises:
marking a global pointer as a default-length pointer.

5. The method of claim 2, wherein marking one or more pointers associated with the source program as default-length pointers further comprises:
marking as a default-length pointer a pointer that escapes the current compilation scope of the source program

6. The method of claim 2, wherein marking one or more pointers associated with the source program as default-length pointers further comprises:
marking as a default-length pointer a field pointer associated with a structure type that escapes the current compilation scope of the source program.

7. The method of claim 1, wherein generating resultant code instructions to maintain the selected segmentation model for the one or more N-bit pointers further comprises:
generating one or more instructions to initialize a base pointer to a lowest N-bit pointer address.

8. The method of claim 1, wherein generating resultant code instructions to maintain the selected segmentation model for the one or more N-bit pointers further comprises:
generating one or more instructions to initialize a base pointer to a non-zero address.

9. The method of claim 1, wherein generating resultant code instructions to maintain the selected segmentation model for the one or more N-bit pointers further comprises:
generating one or more instructions to initialize a plurality of base pointers, wherein each of the base pointers is associated with a type attribute value.

10. The method of claim 1, wherein generating resultant code instructions to maintain the selected segmentation model for the one or more N-bit pointers further comprises:
generating one or more instructions to initialize a plurality of base pointers, wherein each of the base pointers is associated with a type/class attribute pair value.

11. An article comprising:
a machine-readable storage medium having a plurality of machine accessible instructions;
wherein, when the instructions are executed by a processor, the instructions provide for
identifying a selected segmentation model;
marking one or more pointers associated with a source program as N-bit pointers, where N is an integer value less than the architectural limit of a computing device, N being raised to an integer power of two; and
generating resultant code instructions to maintain the selected segmentation model for the one or more N-bit pointers.

12. The article of claim 11, wherein the instructions further provide for:
marking one or more pointers associated with the source program as default-length pointers.

13. The article of claim 12, wherein the instructions that provide for marking default-length pointers further provide for marking the default-length pointers to be of a length corresponding to the architectural limit of the computing device.

14. The article of claim 12, wherein the instructions that provide for marking one or more pointers associated with the source program as default-length pointers further include:
instructions for marking a global pointer as a default-length pointer.

15. The article of claim 12, wherein the instructions that provide for marking one or more pointers associated with the source program as default-length pointers further include:
instructions for marking as a default-length pointer a pointer that escapes the current compilation scope of the source program.

16. The article of claim 12, wherein the instructions the provide for marking one or more pointers associated with the source program as default-length pointers further comprise:
instructions for marking as a default-length pointer a field pointer associated with a structure type that escapes the current compilation scope of the source program.

17. The article of claim 11, wherein the instructions that provide for generating resultant code instructions to maintain the selected segmentation model for the one or more N-bit pointers further comprise:
instructions for generating one or more instructions to initialize a base pointer to a lowest N-bit pointer address.

18. The article of claim 11, wherein the instructions that provide for generating resultant code instructions to maintain the selected segmentation model for the one or more N-bit pointers further include:
instructions for generating one or more instructions to initialize a base pointer to a non-zero address.

19. The article of claim 11, wherein the instructions that provide for generating resultant code instructions to maintain the selected segmentation model for the one or more N-bit pointers further include:
instructions for generating one or more instructions to initialize a plurality of base pointers, wherein each of the base pointers is associated with a type attribute value.

20. The article of claim 11, wherein the instructions that provide for generating resultant code instructions to maintain the selected segmentation model for the one or more N-bit pointers further include:
instructions for generating one or more instructions to initialize a plurality of base pointers, wherein each of the base pointers is associated with a type/class attribute pair value.

21. A compiler, comprising:
a general analyzer to mark one or more pointers associated with a source program as N-bit pointers;
a class analyzer to associate an N-bit pointer with a corresponding class;
a type analyzer to associate an N-bit pointer with a corresponding type/class pair; and
a code modifier to generate resultant code instructions to maintain a selected segmentation model for the N-bit pointers.

22. The compiler of claim 21, wherein the general analyzer marks the one or more pointers as N-bit pointers at least by:
initializing all pointers associated with the source program as N-bit pointers; and
overriding the N-bit initialization to mark as a default-length pointer an N-bit pointer that is a global variable.

23. The compiler of claim 21, wherein the code modifier generates resultant code instructions to maintain the selected segmentation model at least by:
initializing a base pointer.

24. The compiler of claim 23, wherein the code modifier generates resultant code instructions to maintain the selected segmentation model at least by:
generating one or more instructions to subtract the value of the base pointer from an N-bit pointer value for an address-taking operation in the source program.

25. The compiler of claim 23, wherein the code modifier generates resultant code instructions to maintain the selected segmentation model at least by:
generating one or more instructions to add the value of the base pointer to an N-bit pointer value for a dereferencing operation in the source program.
